(19) United States
(12) Patent Application Publication
(10) Pub. No.: US 2019/0238513 A1
(43) Pub. Date: Aug. 1, 2019

(54) DATA DIODES IMPLEMENTED WITH CONTAINERIZED FIREWALLS

(71) Applicant: General Electric Company, Schenectady, NY (US)

(72) Inventors: David Robert SAFFORD, Niskayuna, NY (US); Brandon R. CASTEL, Vancouver (CA); Tom GARDINER, Salem, VA (US)

(21) Appl. No.: 15/884,803

(22) Filed: Jan. 31, 2018

(51) Int. Cl. H04L 29/06

(52) U.S. Cl. CPC H04L 63/0281; H04L 63/0209

(57) ABSTRACT

A method, computer-readable medium, and system including an inside container module to communicate with an inside network internal to a system; an outside container module to communicate with an outside network external to the system; and an inspector module to communicate with the inside container module and the outside container module, the inspector container to control communication of all data between the inside container module and the outside container module, including enforcing single direction data flow directionality between the inspector module and at least one of the outside container module and the inside container module; and the inspector module, the inside container module, and the outside container module each being self-contained and to operate independent of each other.

### BACKGROUND

The field of the present disclosure relates generally to firewalls, and more particularly, to systems, devices and methods of a container based application proxy firewall.

Some traditional application firewall systems may provide forward proxying or reverse proxying. A forward proxy routes internal queries or communications from an internal client out to the internet and a reverse proxy routes external internet queries to an internal application server. For example, some web application firewalls (WAF) may provide a HTTPS proxy with some content inspection (e.g., JSON), where most only do reverse proxying. Additionally, most firewalls that do forward proxying can proxy HTTPS, but do not provide for JSON inspection parsing.

It would be desirable to provide systems and methods for efficient and versatile application proxy firewalls.

### BRIEF DESCRIPTION

In one aspect, an embodiment of the present disclosure relates to a container based application proxy firewall system or application including an inside container module to communicate with an inside network internal to a system; an outside container module to communicate with an outside network external to the system; and an inspector module to communicate with the inside container module and the outside container module, the inspector container to control communication of all data between the inside container module and the outside container module, including enforcing single direction data flow directionality between the inspector module and at least one of the outside container module and the inside container module; and the inspector module, the inside container module, and the outside container module each being self-contained and to operate independent of each other.

In other embodiments, a process may be executed to perform at least some of the features of the systems and applications disclosed herein. In yet another example embodiment, a tangible medium may embody executable instructions that can be executed by a processor-enabled device or system to implement at least some aspects of the systems and applications of the present disclosure.

### DRAWINGS

These and other features, aspects, and advantages of the present disclosure will become better understood when the following detailed description is read with reference to the accompanying drawings in which like characters represent like parts throughout the drawings, wherein:

FIG. 1 is an illustrative example of a traditional application proxy firewall;

FIG. 2 is an illustrative example of a container based application proxy firewall, according to some embodiments herein;

FIG. 3 is an illustrative example of container based application proxy firewalls, including data diode features, according to some embodiments herein; and

FIG. 4 is an illustrative depiction of a block diagram of a system or device that can support some processes disclosed herein.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

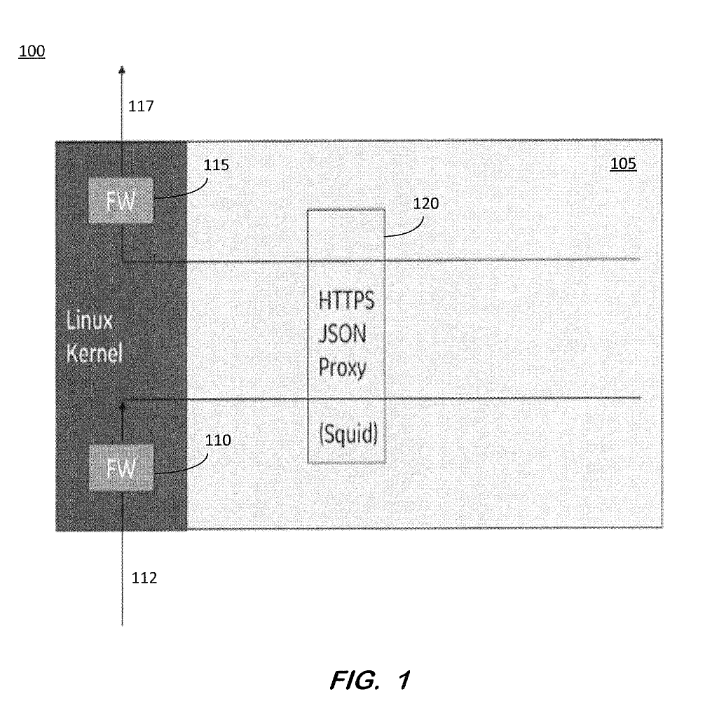

FIG. 1 is an illustrative example of a traditional application proxy firewall. Referring to FIG. 1, a system 100 includes a host computer 105. Host computer 105 may be referred to as being “dual homed”. That is, host 105 includes two (i.e., dual) network interfaces, one network interface 110 to interface with an “inside” network 112 and one network interface 115 to interface with an “outside” network 117. In some aspects, host 105 may run a traditional operating system (e.g., Linux) and a proxy application 120 executes to proxy application data between the two interfaces. In system 100, basic firewall rules, embodied in iptables for example, may perform simple input and output filtering for the inside and outside interfaces 110 and 115, respectively. Proxy application 120 may be responsible for more complex tasks and functions such as content inspection, logging, and forwarding. In the example of FIG. 1, proxy application 120 may be implemented by Squid software and provides forward proxying of HTTPS.

In some aspects, proxy application 120 (and similar proxy applications) may be characterized as being run as a normal application. As such, proxy application 120 can see everything on the host 105. In mandatory access control terms, proxy application 120 is a privileged guard process and is able to violate integrity rules. In some regards, since proxy application 120 performs all of the complex tasks and functions such as content inspection, logging, and forwarding, its implementation may require a rather large and complex program (e.g., 300K lines of code). For such a large program, it may be difficult to trace, inspect, and log all data flow paths managed by the application. Furthermore, monolithic proxy application 120 may act as a single point of failure, where a compromise of the proxy application might result in the system 100 being at risk or otherwise compromised (e.g., without firewall protection).

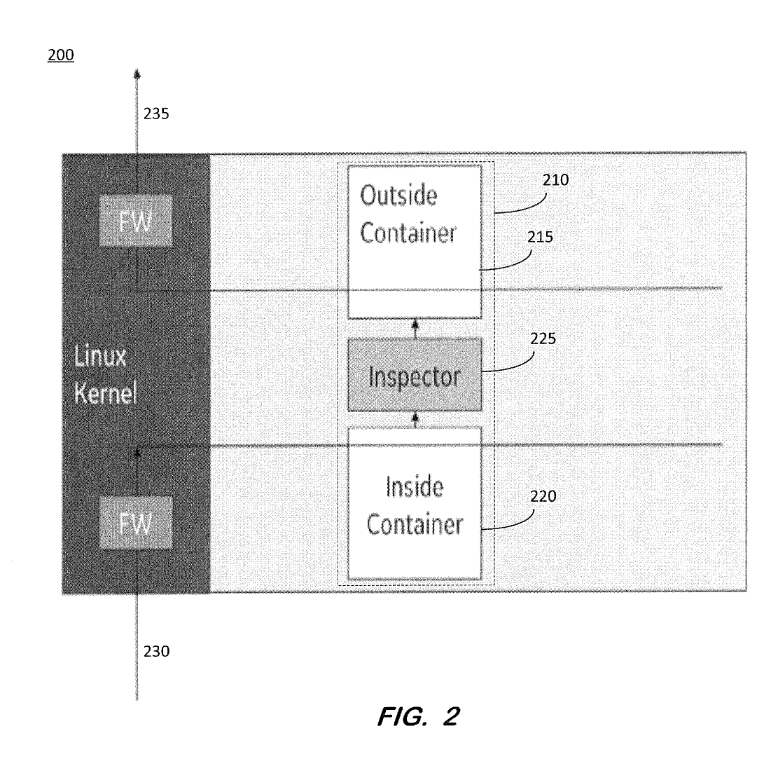

FIG. 2 is an illustrative example of a system 200, including a container based application proxy 210, in accordance with some embodiments herein. Application proxy firewall 210 runs on a host computer, system, or platform 205. Computer or platform 205 may include Linux, but other operating systems and environments are within the scope of the present disclosure. Application proxy firewall 210 is modularized into three different components. Containers are used to isolate proxy functions from each other, as well as from the system 205. Application proxy firewall 210 includes three distinct components, including an outside container module 215, an inside container module 220, and an inspector module 225. Each of the three components 215, 220, and 225 executes in its own container.

Outside container module 215 operates to connect and communicate only with outside network 235. Inside container module 220 only connects and communicates with inside network 230. Inspector module 220 runs in its own container and provides a data path between inside container module 220 and outside container module 215. In some embodiments, inspector module 225 may provide the only data path between outside container module 215 and inside container module 220. Inspector module 225 may provide a single point of inspection for application proxy firewall 210.

In some embodiments, inspector module 225, inside container module 220, and outside container module 210 may be at least one of deployable and configurable within a common or same application. In some embodiments, each of the inspector module 225, inside container module 220, and outside container module 215 are at least one of being deployable and configurable deployed in an application, independent of the other modules (i.e., different programs). In some embodiments, the modularized containers may be reused in combination with other module container implementations to form an application proxy firewall suitably compatible with internal and external networks and devices, as well as multiple different protocols. In some aspects, the modular container components comprising an application proxy firewall disclosed herein may be individually customized to interface with other module containers (i.e., inside container module, outside container module, and inspector module), resources, devices, and networks as needed to effectively interface with such other entities.

In some aspects, application proxy firewall 210 may be simpler, easier, and more efficient to implement than, for example, traditional monolithic application firewalls. In some aspects, instead of one large application proxy firewall 210 (e.g., 300K lines of code) each of outside container module 215, inside container module 220, and inspector module 225 may independently operate within its own container. By executing within its own container, each of outside container module 215, inside container module 220, and inspector module 225 may be isolated from each other, as well as from other processes operating of platform 205.

In some embodiments, isolation between outside container module 215, inside container module 220, and inspector module 225 may facilitate improved verification as compared to a traditional proxy application (e.g., FIG. 1, 105) since each of outside container module 215, inside container module 220, and inspector module 225 might be verified independently of the other. As an example in some embodiments, even if there were a bug, fault, or other compromise within one of the outside container module 215, inside container module 220, and inspector module 225, said bug, fault, or other compromise would not compromise the platform 205 since each of the outside container module 215, inside container module 220, and inspector module 225 are executed within a container that is isolated from the operating system of the platform and is therefore isolated from other components that also execute within their own container.

As a further example, outside container 215 may only communicate with outside network 235 and cannot communicate with the inside network. Accordingly, even if outside container module 215 is somehow compromised, platform 205 or other containerized modules 220 and 225 will not be compromised since the outside(inside) container module cannot talk/communicate directly with inside(outside) container module. In some aspects, if outside container module 215 is corrupted by an attack from outside network 235, outside container module 215 cannot see any inside traffic (via inside container module 220) or otherwise compromise any other processes running on platform 205.

In some embodiments, there is a directed path of point-to-point connections from inside container module 220 to inspector module 225 and a directed path of point-to-point connections from inspector module 225 to outside container module 215.

In some embodiments, all data is communicated through inspector module 225. In some embodiments, the only way to get data in or out of the platform 205 is through inspector 225.

In some embodiments, in mandatory access control terms, only inspector module 225 of proxy application 210 is a privileged guard process, able to violate integrity rules. In some aspects, constraints of the inspector module's container might limit its ability to violate integrity rules and other aspects. In some embodiments, data flows in the individual containerized modules comprising container based application proxy firewalls such as proxy application 210 might be detected, logged, and/or inspected more efficiently and/or easier as compared to a traditional monolithic application proxy firewall. In some embodiments, a compromise (e.g., bug, fault, attack., etc.) of any one or more of the outside container module 215, inside container module 220, and inspector module 225 can be fully contained within the compromised container module.

In some use-cases and operational environments, there may be one or more security requirements applicable to application communications. In some environments, such as but not limited to, power plant control management systems and other business use-cases, there may be requirement(s) that all application communications going to or from a platform's controllers and other devices to external network(s) and device(s) be inspected and filtered. The firewall must proxy all applications with content inspection on all inbound and outbound communications. Some requirements might specify that a firewall must proxy and inspect all such traffic, and be able to log, alert, block, and potentially modify the data (e.g., outbound data might be modified for transparent redirection to local resource(s)). In some embodiments, application proxy firewalls herein may also be configured to be operable to provide traditional packet level filtering, notwithstanding any additional functionalities disclosed herein for some embodiments.

In some embodiments, an application-level proxy firewall is provided that includes an ability for an operator (or other entity) to monitor interactive proxied connections. In some embodiments such as the example container based application proxy firewall 210 of FIG. 2, the outside container module, the inside container module, and the inspector module may be standardized to the extent that each modularized container can interface with devices and networks using a standard communication protocol. Furthermore, in accordance with some aspects herein, an application programming interface (API) may be defined for an inspection module (e.g., FIG. 2, 225) so that an inspector module herein can provide monitoring and control functionality of a monitored proxy to a firewall management interface. In some aspects, the API may include reusable interface(s). In some embodiments, the monitoring and control functionality may provide a measure of improved security protection.

In some use-cases and environments, a key concern in network security may relate to the concept of a data diode where application data may be allowed to flow strictly in one direction. This restrictive flow of application data may be may be desired so that a less trusted data consumer or receiver is provably not able to attack a sensitive data provider. In general, networks depend on and use bidirectional data flows, including for acknowledgements of data transfers and congestion control.

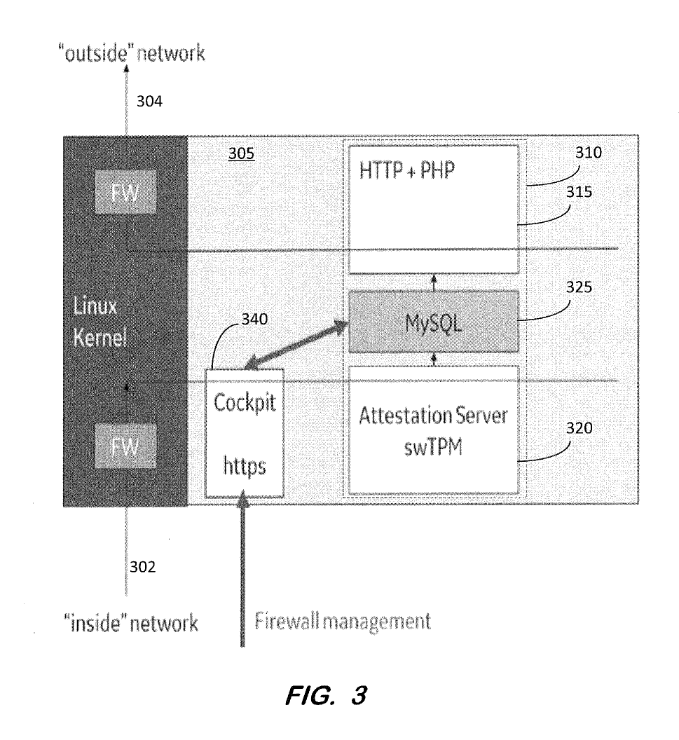

FIG. 3 is an illustrative example of a data diode implemented in a containerized application proxy, in accordance with some embodiments herein. System 300 includes a Linux based platform 305 on which container based application proxy 310 and 315 are running. Platforms using different protocols are within the scope of the present disclosure. Application proxy 310 comprises an outside container module 315, an inside container module 320, and an inspector module 325. In some regards, outside container module 315 communicates with outside network 304, inside container module 320 communicates with inside network 302, and inspector module 325 communicates with both outside container module 310 and inside container module 320.

The containerized components of the outside container module 310, the inside container module 320, and the inspector module 325 are each isolated from each other and other process running on platform 305, by virtue of their respective containers. In an embodiment of the example of FIG. 3, containerized inspector module 325 may be configured to provide only write to the inside container module 320 and only read to the outside component 315. Stated another way, inside container module 320 can only write to the inspector module and outside container module 315 can only read from to the inspector module. In some respects, the inspector module need only implement blinded queuing of the data to have provable flow directionality.

In some embodiments, containerized firewalls herein may enforce one-way data communication flows to effectuate a data diode. Such data communication control may be desired and/or very useful, particularly across a sensitive network infrastructure. In the example of FIG. 3, data may be restricted to flow between inside container module 320 in the direction illustrated and data may be further restricted to flowing from the inspector module 325 to outside container module 315 as shown. In the example of FIG. 3, bidirectionality terminates in outside container 310 such that the outside container can read and write data to outside network 304, but only reads data from inspector module 325. For inside container module 320, all (i.e., bidirectional) data flows including, for example, acknowledgements may be sent and received to/from inside network 302, but the outside container module can only data write to inspector 325. Inspector module 325 enforces the one direction data flow restrictions.

The example of FIG. 3 application proxy 310 may be an instantiation of a containerized attestation application proxy such as, for example, an integrity attestation server. Outside container module 315 may read attestation results from a database running in inspector module 325 (e.g., MySQL, although other implementations may be possible). The outside container module 315 may further operate to display the attestation results to outside browsers (not shown). Inside container module 320 can be limited to writing data to the MySQL database. In the present example, inside container module 320 accepts attestation data from inside clients (not shown), validates the data, and writes the results to the MySQL database running on the inspector module 325. The combination of the inside container module being limited to write to the database and the outside container module being limited to reading from the database operates to enforce the “data diode”. All transactions may be logged by inspector 325 for further review via UI (e.g., Cockpit) 340. UI 340 can view the inspector logs and, in some embodiments, kill the inspector container (e.g., via a “kill switch”).

In some aspects, a containerized application proxy firewall disclosed herein that implements a “data diode” as disclosed herein may have advantages over traditional hardware data diodes implemented at the network level. The data diodes of some embodiments herein, being implemented within a containerized application proxy firewall at an application level, can maintain standard bidirectional network flows while also enforcing data direction restrictions. Applicants recognized that the application level containerized application proxy firewall of some embodiments herein forward all data. As such, these application level containerized application proxy firewalls provide an ideal location to enforce data flow directionality. The data flow directionality associated with data diodes herein may be implemented efficiently and very effectively (i.e., strongly enforced) in the application level containerized application proxy firewall of some embodiments herein.

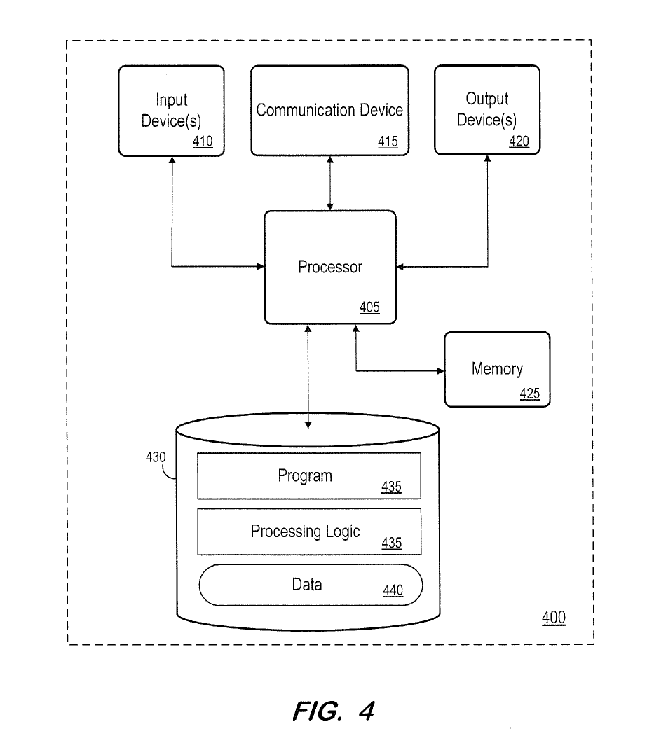

FIG. 4 is an illustrative block diagram of apparatus 400 according to one example of some embodiments. Apparatus 400 may comprise a computing apparatus and may execute program instructions to perform any of the functions described herein. Apparatus 400 may comprise an implementation of server, a dedicated processor-enabled device, a user entity device, and other systems, including a cloud server embodiment of at least parts of a platform or framework disclosed herein. For example, apparatus 400 may implement at least a portion of platform 205, 305, and 405 in FIGS. 2, 3, and 4, respectively. Apparatus 400 may include other unshown elements according to some embodiments.

Apparatus 400 includes processor 405 operatively coupled to communication device 415 to communicate with other systems, data storage device 430, one or more input devices 410 to receive inputs from other systems and entities, one or more output devices 420 and memory 425. Communication device 415 may facilitate communication with other systems and components, such as other external computational assets and data. Input device(s) 410 may comprise, for example, a keyboard, a keypad, a mouse or other pointing device, a microphone, knob or a switch, an infra-red (IR) port, a docking station, and/or a touch screen. Input device(s) 410 may be used, for example, to enter information into apparatus 400. Output device(s) 420 may comprise, for example, a display (e.g., a display screen) a speaker, and/or a printer.

Data storage device 430 may comprise any appropriate persistent storage device, including combinations of magnetic storage devices (e.g., magnetic tape, hard disk drives and flash memory), solid state storages device, optical storage devices, Read Only Memory (ROM) devices, Random Access Memory (RAM), Storage Class Memory (SCM) or any other fast-access memory. Data storage device 430 might store speech pattern profiles.

Program 435 may comprise program instructions executed by processor 405 to cause apparatus 400 to perform any one or more of the processes described herein, including but not limited to aspects of the container based application proxies disclosed herein. Processing logic 435 may be used for controlling processor 405. Embodiments herein are not limited to execution of these processes by a single apparatus.

Data 440 (either cached or a full database) may be stored in volatile memory such as memory 425. Data storage device 430 may also store data and other program code for providing additional functionality and/or which are necessary for operation of apparatus 400, such as device drivers, operating system files, etc. Data 440 may include data related different protocols.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed includes:

1. A container based application proxy firewall system comprising:
an inside container module to communicate with an inside network internal to a system;
an outside container module to communicate with an outside network external to the system; and
an inspector module to communicate with the inside container module and the outside container module, the inspector container to control communication of all data between the inside container module and the outside container module, including enforcing single direction data flow directionality between the inspector module and at least one of the outside container module and the inside container module; and the inspector module, the inside container module, and the outside container module each being self-contained and to operate independent of each other.

2. The system of claim 1, wherein the inspector module enforces single direction data flow directionality between the inspector module and both the outside container module and the inside container module.

3. The system of claim 1, wherein the inspector module, the inside container module, and the outside container module are at least one of being deployable and configurable within a common application.

4. The system of claim 1, wherein each of the inspector module, the inside container module, and the outside container module are at least one of being deployable and configurable deployed in an application, independent of the other modules.

5. The system of claim 1, wherein a proxy function executed by one of the inspector module, the inside container module, and the outside container module is isolated from the other modules.

6. The system of claim 5, wherein the proxy function executed by one of the inspector module, the inside container module, and the outside container module is further isolated from other processes executing in the system.

7. The system of claim 1, wherein the inside container module is operable to only communicate with the inside network; the outside container module is operable to only communicate with the outside network; and the inspector module is operable to communicate with both the inside container module and the outside container module.

8. The system of claim 1, wherein the inspector module is a single point of inspection for the system.

9. A computer-implemented method, the method comprising:
an inside container module communicating with an inside network internal to a system;
an outside container module communicating with an outside network external to the system; and
an inspector module communicating with the inside container module and the outside container module, the inspector container to control communication of all data between the inside container module and the outside container module, including enforcing single direction data flow directionality between the inspector module and at least one of the outside container module and the inside container module; and the inspector module, the inside container module, and the outside container module each being self-contained and to operate independent of each other.

10. The method of claim 9, wherein the inspector module enforces single direction data flow directionality between the inspector module and both the outside container module and the inside container module.

11. The method of claim 9, wherein the inspector module, the inside container module, and the outside container module are at least one of being deployable and configurable within a common application.

12. The method of claim 9, wherein each of the inspector module, the inside container module, and the outside container module are at least one of being deployable and configurable deployed in an application, independent of the other modules.

13. The method of claim 9, wherein a proxy function executed by one of the inspector module, the inside container module, and the outside container module is isolated from the other modules.

14. The method of claim 13, wherein the proxy function executed by one of the inspector module, the inside container module, and the outside container module is further isolated from other processes executing in the system.

15. The method of claim 9, wherein the inside container module is operable to only communicate with the inside network; the outside container module is operable to only communicate with the outside network; and the inspector module is operable to communicate with both the inside container module and the outside container module.

16. The method of claim 9, wherein the inspector module is a single point of inspection for the system.

17. A non-transitory computer-readable medium storing program instructions executable by a processor of a computing system, the medium comprising:
instructions for an inside container module to communicate with an inside network internal to a system;
instructions for an outside container module to communicate with an outside network external to the system; and
instructions for an inspector module to communicate with the inside container module and the outside container module, the inspector container to control communication of all data between the inside container module and the outside container module, including enforcing single direction data flow directionality between the inspector module and at least one of the outside container module and the inside container module; and the inspector module, the inside container module, and the outside container module each being self-contained and to operate independent of each other.

18. The medium of claim 17, wherein the inspector module enforces single direction data flow directionality between the inspector module and both the outside container module and the inside container module.

19. The medium of claim 17, wherein the inspector module, the inside container module, and the outside container module are at least one of being deployable and configurable within a common application.

20. The medium of claim 17, wherein each of the inspector module, the inside container module, and the outside container module are at least one of being deployable and configurable deployed in an application, independent of the other modules.
